(19) United States
(12) Patent Application Publication
(10) Pub. No.: US 2024/0095667 A1
(43) Pub. Date: Mar. 21, 2024

(54) DYNAMICALLY OPTIMIZING INVENTORY LEVELS AMONG MULTIPLE DISTRIBUTION WAREHOUSES THROUGH SHIPMENT REALLOCATIONS AND TRANSFER SHIPMENTS

(71) Applicant: AutoScheduler.AI LP, Franklin, TN (US)

(72) Inventors: Felipe Santos Boffo, Porto Alegre (BR); Andrew Gibson, Rogers, AR (US); Agustin Pecorari, Buenos Aires (AR); Keith D. Moore, Leander, TX (US)

(21) Appl. No.: 18/369,569

(22) Filed: Sep. 18, 2023

Related U.S. Application Data
(60) Provisional application No. 63/538,969, filed on Sep. 18, 2023.
(60) Provisional application No. 63/462,237, filed on Apr. 26, 2023.
(60) Provisional application No. 63/408,008, filed on Sep. 19, 2022.

(51) Int. Cl. G06Q 10/087; G06Q 10/04; G06Q 10/083

(52) U.S. Cl. CPC G06Q 10/087; G06Q 10/04; G06Q 10/0838

(57) ABSTRACT

A system, method and/or computer usable program product for dynamically optimizing inventory among multiple distribution warehouses across multiple time periods within a time span, including receiving an identified configuration of the multiple distribution warehouses including associated shipping lanes, receiving an identified set of good types, receiving an identified set of constraints and capacities applicable to the identified configuration, receiving a set of incentive based weights associated with inventory levels of the set of goods and with shipments on the shipping lanes, generating a model of the multiple distribution warehouses including the identified configuration, the identified set of good types, the identified set of constraints and capacities, and the incentive based weights, the model including incoming shipment destinations and outgoing shipment originations as decision variables and including transfer shipments with good types and quantities thereof as decision variables, receiving current inventory levels of the set of good types, receiving a set of scheduled shipments over the time span, determining inventory levels for each of the good types for each distribution warehouse for each of a set of time periods across the time span, and utilizing the model to optimize inventory levels for each of the good types in each distribution warehouse across the set of time periods across the multiple distribution warehouses by identifying reallocations of incoming shipment destinations, reallocations of outgoing shipment originations, and good types and quantities thereof of transfer shipments.

### PRIORITY CLAIM

This application claims priority to U.S. Provisional Patent Application No. 63/408,008, filed Sep. 19, 2022, entitled “AUTOMATICALLY AND DYNAMICALLY MANAGING DISTRIBUTION WAREHOUSE SCHEDULING AND OPERATIONS”, with Attorney docket number AS2201US01P; to U.S. Provisional Patent Application No. 63/462,237, filed Apr. 26, 2023, entitled “AUTOMATICALLY AND DYNAMICALLY MANAGING DISTRIBUTION WAREHOUSE SCHEDULING AND OPERATIONS”, with Attorney docket number AS2202US01P; and to U.S. Provisional Patent Application No. 63/538,969, filed Sep. 18, 2023, entitled DYNAMICALLY OPTIMIZING INVENTORY LEVELS AMONG MULTIPLE DISTRIBUTION WAREHOUSES THROUGH SHIPMENTS REALLOCATIONS AND TRANSFER SHIPMENTS″, with Attorney docket number AS2203US01P, the contents of each of the foregoing which are incorporated by reference herein in their entirety.

### BACKGROUND

### Technical Field

A system and method relate generally to dynamically optimizing inventory levels among multiple distribution warehouses, and more specifically to a computer implemented system and method for dynamically optimizing inventory levels among multiple distribution warehouses through reallocating incoming and outgoing shipments and implementing transfer shipments among the distribution warehouses.

### Description of Related Art

A distribution warehouse may be utilized for receiving shipments of goods from suppliers, storing those goods in inventory, and repackaging and shipping those goods to customers. In addition, transfer shipments between distribution warehouses may be manually scheduled to address inventory shortages and to reduce excess inventory. Suppliers may be manufacturers, assemblers or other producers of goods. Suppliers may also be other providers of goods that utilize distribution warehouses such as resellers, other distributers, ports or other types of non-producers. Customers may be end use customers, retailers, other distributers, etc. In summary, many types of suppliers and customers may utilize a distribution warehouse or set of distribution warehouses.

Fulfilling orders quickly and efficiently from a distribution warehouse onto handling units for shipping is an important part of the operation of many businesses and industries. It is through this process that goods, such as items and other products, may be shipped or otherwise provided for storage in a distribution warehouse, then picked and stacked onto handling units for shipment to customers. There is a need to increase productivity and drive greater efficiency throughout the process. For example, in a consumer products distribution warehouse, to eliminate travel around the distribution warehouse, it's desirable to pick two or more customers' orders at the same time. This may significantly reduce time and effort for order selection, but mistakes are expensive. Even in a “goods to picker” environment, errors may be frequent and are generally increased with concurrent order selection of multiple orders at the same time due to the increased complexities involved.

Supply chains have complexities with constraints, variables, metrics, and performance objectives. In addition, supply chains may have greater variability and unpredictability over time. That is, traffic on those supply chains may vary significantly on a daily basis due to changing conditions outside the supply chain. For example, climatic changes can affect a variety of factors such as highly variable demands for certain items at certain destinations. For another example, labor disruptions at a transportation provider can rapidly affect the availability of transportation units at certain transportation origins. As a result, optimizing the flow of goods through such variable supply chains is also increasingly a complex and difficult task.

Broadly speaking, supply chain management is the management of the flow of goods and services from processing raw materials to providing final products to customers. There are many organizations that utilize a variety of supply chain management tools, either developed internally or acquired from third party vendors. For example, Amazon.com Inc. and Walmart Inc. are very large organizations known for their supply chain management expertise that provide a competitive advantage in the marketplace. In addition, a variety of third party vendors, including SAP SE, Infor Inc., Blue Yonder Inc., Kinaxis Inc., Logility Inc., Bluecrux CVBA, E2open LLC, Manhattan Associates, Transportation|Warehouse Optimization (T|WO), etc. have developed a variety of software tools for managing supply chains. These tools range from accounting systems for tracking the supply chain assets and expenses to planning tools for managing the shipments of goods. Example products are SAP APO (Advanced Planner and Optimizer), Kinaxis RapidResponse and the T|WO AutoO2 and AutoCDO software tools.

Distributed Order Management Systems (DOM) are known for managing future demand by allocating order fulfillment to the most optimal location. For example, if an order is placed for a set of goods, a DOM system may allocate fulfilling that order as well as other orders by scheduling a shipment from warehouse to a customer based on warehouse proximity and current inventory supply availability.

There are many warehouse management systems (WMS) implemented as software available on the market such as SAP Extended Warehouse Management by SAP, Oracle Fusion Cloud Warehouse Management by Oracle, Blue Yonder Warehouse Management by Blue Yonder, Microsoft Dynamics 365 by Microsoft, K.Motion Warehouse Advantage and K.Motion Enterprise 3PL by Korber Supply Chain, Manhattan Associates Warehouse Management for IBM i(WMi) and Warehouse Management for Open Systems by Warehouse Associates, Click Reply by Reply, TECSYS Warehouse Management by Teksys, Reflex WMS by Hardis Group, SnapFulfil by Synergy Logistics, Vin eRetail WMS by Vinculum, Infor WMS by Infor, EPG LFS by Ehrhardt+Partner Group, vTradEX Warehouse Management System by vTradEx, Microlistics WMS by Microlistics, etc. These types of systems can range from recording the arrival and departure of inventory to managing labor and space resource utilization and material flows towards fulfilling customer orders. They may include a basic inventory system, a more advanced system which analyzes inventory levels and track time and labor spent in various activities, to a system that can communicate with other systems.

For example, Blue Yonder's WMS utilizes inventory management including processing inbound and outbound inventory, managing inventory stock levels as well as managing labor resources by directing work to personnel on the floor. Planners and taskers inside of the facility are responsible for working with the Blue Yonder WMS to allocate inventory to shipments, wave out work, and release tasks into a “work queue”, in which a combined zoning strategy and task prioritization inside of the WMS “directs” work to the appropriate employee based on their permissions, proximity, and the task priority (known as the 3 P's in warehousing).

### SUMMARY

A system, method and/or computer usable program product for dynamically optimizing inventory among multiple distribution warehouses across multiple time periods within a time span, including receiving an identified configuration of the multiple distribution warehouses including associated shipping lanes, receiving an identified set of good types, receiving an identified set of constraints and capacities applicable to the identified configuration, receiving a set of incentive based weights associated with inventory levels of the set of goods and with shipments on the shipping lanes, generating a model of the multiple distribution warehouses including the identified configuration, the identified set of good types, the identified set of constraints and capacities, and the incentive based weights, the model including incoming shipment destinations and outgoing shipment originations as decision variables and including transfer shipments with good types and quantities thereof as decision variables, receiving current inventory levels of the set of good types, receiving a set of scheduled shipments over the time span, determining inventory levels for each of the good types for each distribution warehouse for each of a set of time periods across the time span, and utilizing the model to optimize inventory levels for each of the good types in each distribution warehouse across the set of time periods across the multiple distribution warehouses by identifying reallocations of incoming shipment destinations, reallocations of outgoing shipment originations, and good types and quantities thereof of transfer shipments.

### BRIEF DESCRIPTION OF THE DRAWINGS

Embodiments of a system and method for dynamically optimizing inventory levels among multiple distribution warehouses through reallocating incoming and outgoing shipments and implementing transfer shipments among the distribution warehouses may be better understood, and its numerous features and advantages made apparent to those skilled in the art by referencing the accompanying drawings. The use of the same reference number throughout the several figures designates a like or similar element.

FIG. 1 depicts a high level diagram of shipments from suppliers to distribution warehouses, from distribution warehouses to customers, as well as between distribution warehouses, in which various embodiments of the present disclosure may be implemented.

FIGS. 2A through 2C depict diagrams of inventory supply and demand of a single good for three different distribution warehouses, with reference to FIG. 1, in which various embodiments of the present disclosure may be implemented.

FIG. 3 depicts a diagram of the utilization of supply to meet demand across distribution warehouses, in which various embodiments of the present disclosure may be implemented.

FIG. 4 depicts a diagram of a utilization of time series with discrete time buckets for optimizing inventory levels across multiple distribution warehouses, in which various embodiments of the present disclosure may be implemented.

FIG. 5 depicts a high level block diagram 500 of an inventory optimization system for dynamically optimizing inventory levels among multiple distribution warehouses through reallocating incoming and outgoing shipments and implementing transfer shipments, in which various embodiments of the present disclosure may be implemented.

FIG. 6 depicts a flow diagram of a process for implementing and maintaining the static data of the inventory optimization system towards generating an inventory optimization model, in which various embodiments of the present disclosure may be implemented.

FIG. 7 depicts a flow diagram of a process for invoking, collecting, manipulating and storing dynamic data of the inventory optimization system, in which various embodiments of the present disclosure may be implemented

FIG. 8 depicts a flow diagram for optimizing inventory during a time span across multiple distribution warehouses utilizing the generated inventory optimization model, in which various embodiments of the present disclosure may be implemented.

FIG. 9 depicts a block diagram of an illustrative data processing system in which various embodiments of the present disclosure may be implemented.

FIG. 10 depicts a block diagram of an illustrative network of data processing systems in which various embodiments of the present disclosure may be implemented.

### DETAILED DESCRIPTION

Processes and devices may be implemented and utilized for dynamically optimizing inventory levels among multiple distribution warehouses through reallocating incoming and outgoing shipments and implementing transfer shipments among the distribution warehouses. These processes and apparatuses may be implemented and utilized as will be explained with reference to the various embodiments below.

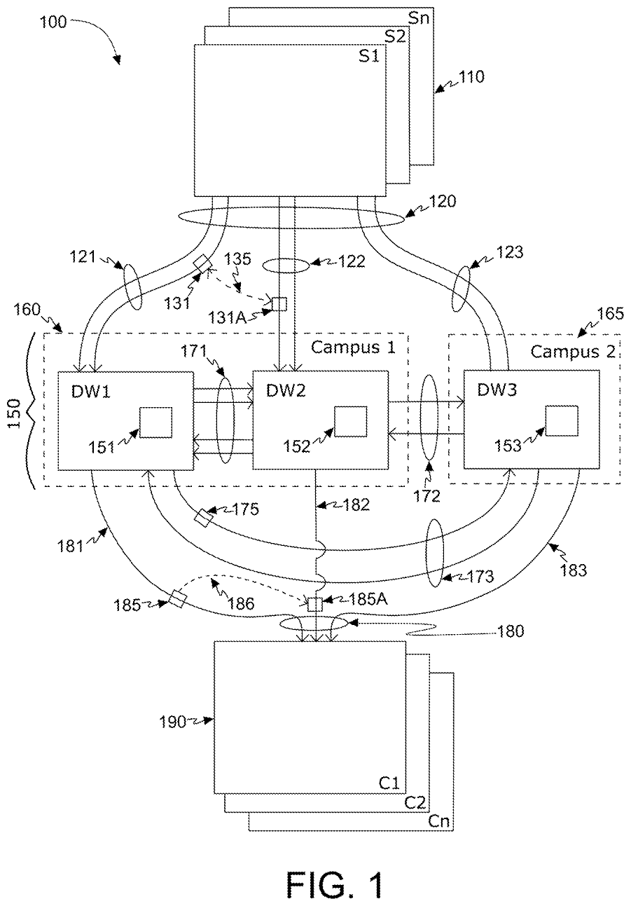

In at least one embodiment, a system and method is provided for dynamically optimizing inventory levels among multiple distribution warehouses through reallocating incoming and outgoing shipments and implementing transfer shipments among the distribution warehouses. FIG. 1 depicts a high level diagram 100 of shipments from suppliers 110 to distribution warehouses 150, from distribution warehouses 150 to customers 190, as well as between distribution warehouses 150, in which various embodiments of the present disclosure may be implemented.

Suppliers 110 may be manufacturers, assemblers, producers or other sources of goods. Suppliers 110 may also be other providers of goods such as resellers, other distributers, ports or other types of non-producers that utilize distribution warehouses 150 for subsequent distribution of those goods to customers 190. Suppliers 110 may include multiple suppliers S1, S2 . . . Sn that the distribution warehouses may receive goods from in common. Distribution warehouses 150 may be facilities utilized for receiving shipments of goods from suppliers 110, possibly storing those goods in inventory (e.g., 151, 152 and 153), and repackaging and shipping those goods to customers 190. Distribution warehouses may also transfer goods among each other. In the present example, distribution warehouses DW1 and DW2 are on a first campus 160 and distribution warehouse DW3 is on a second campus 165 somewhat remote from first campus 160. A campus may include multiple facilities in close proximity to each other, including within the same large building or warehouse. Distribution warehouses 150 may include additional distribution warehouses spread out among additional campuses. Customers 190 may be end use customers, retailers, other distributers, etc. that are destinations or sinks of goods that the distribution warehouses may ship to in common. In summary, many types of suppliers 110 (i.e. sources of goods) and customers 190 (i.e., destinations of goods) may utilize a distribution warehouse or set of distribution warehouses 150. Customers 190 may include multiple customers C1, C2 . . . Cn.

Incoming shipping lanes 120 may be utilized for sending goods from suppliers 110 to distribution warehouses 150. In the present example, supplier S1 may ship goods to distribution warehouse DW1 utilizing shipping lane 121, to distribution warehouse DW2 utilizing shipping lane 122, and to distribution warehouse DW3 utilizing shipping lane 123. Shipping lanes 121, 122 and 123 may include multiple transportation modes each, such as such as a truck and a train, or as a refrigerated truck and a flatbed truck. Each incoming shipping lane 120 can include one or more shipments of goods from suppliers 110 to distribution warehouses 150, such as shown as shipment 131 on shipping lane 121. Additional shipping lanes may be utilized for shipping goods from each supplier to each distribution warehouse. Certain incoming shipments previously scheduled may be reallocated from a given shipping lane to another shipping lane to reallocate the goods contained therein to a different distribution warehouse. For example, previously scheduled incoming shipment 131 from supplier S1 on incoming shipping lane 121 may be reallocated from distribution warehouse DW1 to incoming shipping lane 122 to distribution warehouse DW2 as shipment 131A to address inventory 152 shortages in DW2 as well as to address upcoming outgoing shipments of goods from DW2 to customers. This type of incoming shipment reallocation is described in greater detail herein.

Shipping lanes 170 may be utilizing for transferring goods between distribution warehouses 150. In the present example, shipping lanes 171 may ship goods between DW1 and DW2, shipping lanes 172 may ship goods between DW2 and DW3, and shipping lanes 173 may ship goods between DW3 and DW1. Shipping lanes 171, 172 and 173 may include multiple transportation modes each, such as such as large truck and a small box truck. Each shipping lane 170 can include one or more shipments of goods between distribution warehouses DW1, DW2 and DW3. Additional shipping lanes may be utilized for shipping goods between distribution warehouses 150. Certain transfer shipments may be implemented to reallocate inventory from one distribution warehouse to another distribution warehouse. For example, transfer shipment 175 from distribution warehouse DW1 to distribution warehouse DW3 on shipping lane 173 may be implemented address inventory 153 shortages in DW3 as well as to address upcoming shipments of goods from DW3 to customers. This type of shipment reallocation is described in greater detail herein.

Outgoing shipping lanes 180 may be utilized for sending goods from distribution warehouses 150 to customers 190. In the present example, distribution warehouse DW1 may ship goods to customer C1 utilizing shipping lane 181, distribution warehouse DW2 may ship goods to customer C1 utilizing shipping lane 182, and distribution warehouse DW3 may ship goods to customer C1 utilizing shipping lane 183. Outgoing shipping lanes 181, 182 and 183 may include multiple transportation modes each, such as such as a truck and a train, or as a refrigerated truck and a flatbed truck. Each outgoing shipping lane 180 can include one or more shipments of goods from distribution warehouses 150 to customers 190. Additional shipping lanes may be utilized for shipping goods from each distribution warehouse to each customer. Certain outgoing shipments may be reallocated from a given shipping lane to another outgoing shipping lane to reallocate the goods included in that shipment from a different distribution warehouse. For example, outgoing shipment 185 on shipping lane 181 from distribution warehouse DW1 to customer C1 may be reallocated 186 as outgoing shipment 185A to outgoing shipping lane 182 from distribution warehouse DW2 to address inventory shortages 151 in DW1 as well as to address upcoming outgoing shipments of goods from DW1 to customers. This type of outgoing shipment reallocation is described in greater detail herein.

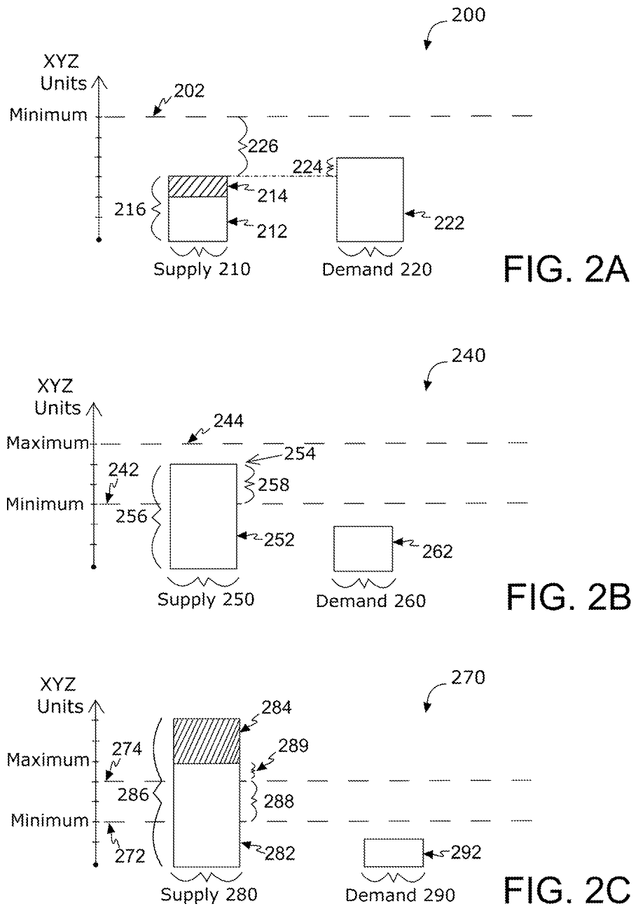

In the present example, inventories of distribution warehouses may be optimized by reallocating previously scheduled shipments from suppliers 110 to distribution warehouses 150, by reallocating previously scheduled shipments from distribution warehouses 150 to customers 190, and by implementing transfer shipments between distribution warehouses 150. FIGS. 2, 3 and 4 provide

FIGS. 2A through 2C depict diagrams 200, 240 and 270 of inventory supply and demand of a single good for three different distribution warehouses, with reference to FIG. 1, in which various embodiments of the present disclosure may be implemented. In the present example, for illustrative purposes, FIG. 2A may correspond to the supply and demand of good XYZ in inventory 151 of distribution warehouse DW1, FIG. 2B may correspond to the supply and demand of good XYZ in inventory 152 of distribution warehouse DW2, and FIG. 2C may correspond to the supply and demand of good XYZ in inventory 153 of distribution warehouse DW3.

In FIG. 2A, in accordance with the present embodiment, supply 210 of good XYZ at DW1 is depicted including newer inventory 212 and older inventory 214 collectively referred to herein as total stock 216. Supply 210 is shown in terms of units of XYZ goods (i.e. a type of goods or good type), which may be in pallets of goods, individual goods, or other units of measure. Newer inventory is inventory that does not have a near term expiration date (i.e., within a predefined time period) whereas older inventory has a near term expiration date (within the predefined time period) and needs to be shipped to customers before it expires. The predefined time period may be predefined by an administrator or other person(s) managing operations of the distribution warehouses. The predefined time period may vary for each good. In the present example, total stock 216 is below a minimum desired inventory level 202 for DW1. Minimum desired inventory level 202 may be predetermined by an administrator or other person(s) managing operations of the distribution warehouses. Alternatively, minimum desired inventory levels may be predetermined based on statistical analysis or by artificial intelligence based on historical data. Demand 220 of good XYZ at DW1 is depicted including scheduled outbound demand 222. Scheduled outbound demand 222 may be based on scheduled shipments of good XYZ from DW1 to customers. As shown, demand 220 of good XYZ exceeds supply 210, thereby creating a shortage 224 such that scheduled outbound demand 222 will not be met. In addition to shortage 224, there is a level demand 226 whereby demand 220 is below a desired minimum inventory 202. As a result of demand 220 exceeding supply 210, not only is inventory of good XYZ below desired minimum 202, scheduled outbound shipments of good XYZ to customers 222 may not be met due to inventory shortage 224 unless adjustments are made to the supply 210 and/or demand 220.

In FIG. 2B, in accordance with the present embodiment, supply 250 of good XYZ at DW2 is depicted including newer inventory 252, with no older inventory 254, collectively referred to herein as total stock 256. Supply 240 is shown in terms of units of XYZ goods, which may be in pallets of goods, individual goods, or other units of measure. In the present example, total stock 256 is above a minimum desired inventory level 242 for DW2, but is below a max desired inventory level 244. As shown, desired minimum inventory level 242 is at a different number of units than desired minimum inventory level 202, which may vary between distribution warehouses. Desired maximum inventory level 244 may be predetermined by an administrator or other person(s) managing operations of the distribution warehouses, statistical analysis, or by artificial intelligence based on historical data. As a result of newer inventory 242 exceeding minimum inventory level 242, there is a surplus 258 of newer inventory 252 potentially available for meeting demand, whether at DW2 or other distribution warehouses. More specifically, demand 260 of good XYZ at DW2 is depicted including scheduled outbound demand 262 (i.e., scheduled shipments of good XYZ from DW2 to customers). As shown, supply 250 exceeds demand 260, thereby enabling the inventory 256 to cover scheduled outbound demand 262 of good XYZ from DW2, but also potentially available for transfer to other distribution warehouses.

In FIG. 2C, in accordance with the present embodiment, supply 280 of good XYZ at DW3 is depicted including newer inventory 282 and older inventory 284, collectively referred to herein as total stock 286. Supply 270 is shown in terms of units of XYZ goods, which may be in pallets of goods, individual goods, or other units of measure. In the present example, total stock 286 is above a minimum desired inventory level 272 for DW3 as well as above a max desired inventory level 274, as indicated by surplus newer inventory 288 and excess newer inventory 289. As shown, desired minimum inventory level 272 and desired maximum inventory level 274 are at a different number of units than desired minimum inventory level 242 and desired maximum inventory level 244, which may vary between distribution warehouses. Demand 290 of good XYZ at DW3 is depicted including scheduled outbound demand 292 (i.e., scheduled shipments of good XYZ from DW3 to customers). As shown, there is surplus newer inventory 288 and excess newer inventory 289 of XYZ goods potentially available for meeting demand, whether at DW3 or other distribution warehouses. In addition, there is older inventory 284 also available for meeting demand, whether at DW3 or other distribution warehouses.

Given the present example depicted in FIGS. 2A through 2C and with reference to FIG. 1, additional inventory needs to be allocated to XYZ supply 210 to meet XYZ demand 220 in DW1. Firstly, shipments including XYZ goods to DW2 or DW3 could be rerouted from suppliers 110 to DW1 to meet demand 220 for XYZ goods. This would reduce the supply 210 of XYZ goods to DW1. This rerouting could include shipments planned in the near term or shipments in progress on shipping lanes 122 or 123. Since DW2 is on the same campus as DW1, it may be easier and more efficient to reallocate an incoming shipment from DW2 to DW1. Alternatively, DW3 has excess inventory as well as older inventory, so it may be more cost effective to reallocate an incoming shipment from DW3 to DW1. However, in either case, such incoming shipments to DW2 or DW3 may contain other goods which may be needed in their currently planned destinations or which may be excessive at DW1. As a result, rerouting incoming shipments from DW2 or DW3 to DW1 may create more supply and demand issues among the distribution warehouses than it resolves.

Secondly, shipments including XYZ goods from DW1 to customers 190 could be reallocated to shipping from DW2 or DW3. This would reduce the demand 220 of XYZ goods from DW1. Since DW2 is on the same campus as DW1, it may be easier and more efficient to reallocate an outgoing shipment from DW1 to DW2. Alternatively, DW3 has excess inventory as well as older inventory, so it may be more cost effective to reallocate an outgoing shipment from DW1 to DW3. However, in either case, such outgoing shipments from DW1 may contain other goods which may be in short supply in DW2 or DW3. As a result, reallocating DW1 outgoing shipments to DW2 or DW3 may create more supply and demand issues among the distribution warehouses than it resolves.

Thirdly, XYZ goods may be transferred from DW2 or DW3 to DW1 by utilizing a transfer shipment. Such a transfer shipment may be newly scheduled for this transfer or a currently scheduled transfer shipment may be supplemented with XYZ goods from DW2 or DW3 to DW1. Since DW2 is on the same campus as DW1, it may be easier and more efficient to utilize a transfer shipment from DW2 to DW1. Alternatively, DW3 has excess inventory as well as older inventory, so it may be more cost effective to reallocate a transfer shipment from DW3 to DW1.

Determining whether to reallocate previously scheduled incoming shipments, outgoing shipments or utilizing transfer shipments to address inventory shortages is a complex task. Many such factors need to be considered including available shipments for reallocation (i.e., reallocation of the destination of previously scheduled incoming shipments and reallocation of the origination of previously scheduled outgoing shipments), other goods included in potentially reallocated shipments, distances between distribution warehouses, available vehicles for transfer shipments, etc. In order to address this complex task, certain factors are clearly defined in the present embodiment such as described in some detail above. These factors are described below in greater detail.

In the present embodiment, level demand is the quantity of inventory of a particular good needed to comply with predetermined minimum stock levels. This may be predetermined at an item or group of items level. As described above, the predetermined minimum stock level may be may be predetermined by an administrator or other person(s) managing operations of the distribution warehouses, statistical analysis, or by artificial intelligence based on historical data. In addition, this predetermined minimum stock level may be static or dynamic over time, particularly if artificial intelligence is utilized in setting and adjusting that predetermined minimum. In the present embodiment, total demand of a good is the amount of that good needed in inventory to fulfill shipments of that good in scheduled shipments. In the present embodiment, short demand is the quantity of inventory of that good needed to fully cover planned outbound shipments which is not currently in inventory. Short demand may be time dependent. That is, depending on a chosen window of time, short demand may vary based on incoming and outgoing shipments. In the present embodiment, outbound demand is the total demand of inventory needed to fulfill scheduled outbound shipments, minus short demand. Alternative embodiments may utilize alternative definitions or calculations of these demand factors.

In the present embodiment, older stock is inventory that is near an expiration date. Such an expiration date may be predefined by the supplier, by government regulations, or other factors. The near date is a date preceding the expiration date whereby the inventory is considered older stock. The difference between near date and expiration date is generally expressed in days and may be predefined by a database at an item (i.e., good) or group of items level. The predefined difference between near date and expiration date may be provided by an administrator or other person(s) managing operations of the distribution warehouses, statistical analysis, or by artificial intelligence based on historical data. In addition, this predefined difference between near date and expiration date may be static or dynamic over time, particularly if artificial intelligence is utilized in setting and adjusting that predefined difference between near date and expiration date. In the present embodiment, surplus inventory is newer inventory that is above the minimum stock level, not including excess stock and older stock. In addition, excess inventory is newer inventory that is above the predetermined maximum stock level, not including older stock. As described above, the predetermined maximum stock level may be may be predetermined by an administrator or other person(s) managing operations of the distribution warehouses, by statistical analysis, or by artificial intelligence based on historical data. In addition, this predetermined maximum stock level may be static or dynamic over time, particularly if artificial intelligence is utilized in setting and adjusting that predetermined maximum. Alternative embodiments may utilize alternative definitions or calculations of these supply factors.

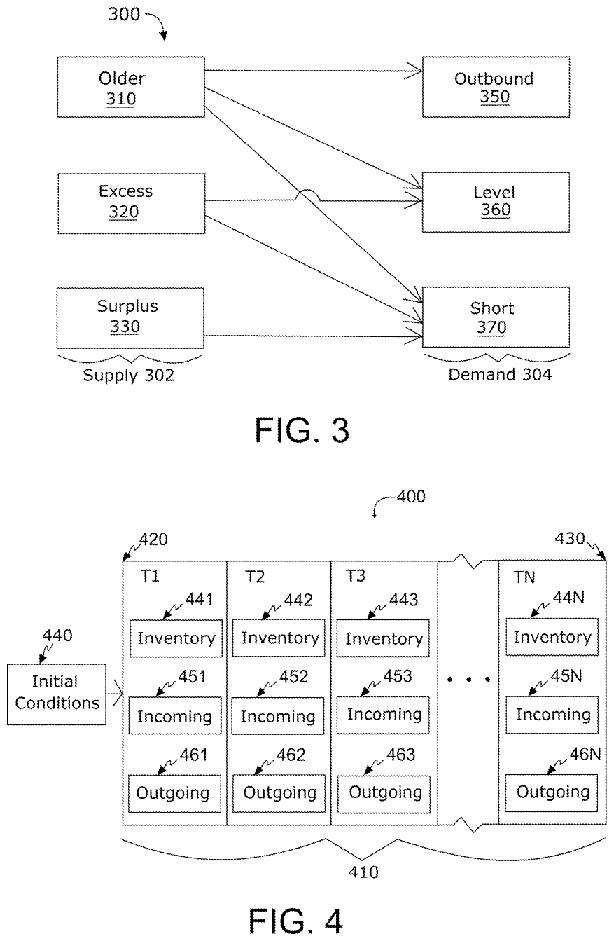

FIG. 3 depicts a diagram 300 of the utilization of supply 302 to meet demand 304 across distribution warehouses, in which various embodiments of the present disclosure may be implemented. That is, some supply of a good in a first distribution warehouse may be utilized to meet demand of that good in a second distribution warehouse, whether by reallocating shipments or by utilizing transfer shipments.

In the present embodiment, rather than allow all types of inventory supply to be eligible for shipment to another warehouse, certain restrictions on that redistribution of inventory supply may be established as follows. Preferably, such restrictions may be soft constraints or simply weighted rewards and penalties for balancing such restrictions against other factors under consideration. For example, a shipment may be reallocated for shipping certain goods from a first distribution warehouse to a second different distribution warehouse experiencing shortages of those goods, even if that shipment may contain other goods that are in excess in the second distribution warehouse, so long as the weighted rewards of the reallocation are greater than the weighted penalties for doing so. Such restrictions may also be hard constraints such that they are not violated through suggested reallocation of shipments or transfers. For example, a shipment containing needed goods may not be reallocated from a first distribution warehouse to a second distribution warehouse if that shipment contains any goods that are in excess in the second distribution warehouse. Instead, a transfer of those needed goods may be transferred from the first distribution warehouse to the second distribution warehouse in a transfer shipment. Such restrictions, whether soft restrictions or hard restrictions, may better balance or simplify the redistribution of inventory supply as described herein.

In accordance with the present embodiment, older inventory supply 310 from one distribution warehouse, may be utilized to fulfill a shortage 370, a level demand 360 or even outbound shipments 350 of another distribution warehouse. These limited restrictions for redistributing older inventory is due to the substantial need to avoid spoilage. For example, with reference to FIG. 2, older inventory 214 of DW1 may be eligible for redistribution to DW2 or DW3 to meet demand for scheduled outgoing shipments 262 and 292. However, such redistribution of DW1 older inventory 214 is unlikely as there is sufficient outgoing shipments from DW1 222 for utilizing all such older inventory 214. In another example with reference to FIG. 2, older inventory 284 of DW3 may be eligible for redistribution to DW2 to meet demand for scheduled outgoing shipments 262 as well as to DW1 to meet demand to fulfill shortage 224, to meet level demand 226, or for fulfilling scheduled outgoing shipments 222. Such a redistribution of some of DW3 older inventory 284 may be likely in the present example as there is insufficient outgoing shipments from DW3 292 for utilizing all such older inventory 284. For example, half of older inventory 284 may be transfer shipped to DW1 to fulfill short demand 224. Alternatively, an outgoing shipment from DW1 may be reallocated to DW3 for shipment of a portion of older inventory 284 to a customer.

In accordance with the present embodiment, excess inventory supply 320 (i.e., newer inventory above a maximum desired inventory level) from one distribution warehouse, may be utilized to fulfill shortage 370 or level demand 360 of another distribution warehouse. Unlike older inventory which may expire, excess inventory may not be utilized simply for meeting demand outbound shipments 350 of another distribution warehouse in the present embodiment. Although there is a cost with having excess inventory for some period of time, that cost is typically less than the cost of older inventory expiring, hence the greater restrictions of usage of excess inventory supply 320. For example, with reference to FIG. 2, excess newer inventory 289 of DW3 may be eligible for redistribution to DW1 to meet level demand 226. As there are no shortages or level demand in DW2 in the present example, excess inventory 289 would not be eligible for redistribution to DW2.

In accordance with the present embodiment, surplus inventory supply 330 (i.e., newer inventory above a minimum desired inventory level but below a maximum desired inventory level) from one distribution warehouse, may be utilized to fulfill shortage 370 of another distribution warehouse. Unlike older inventory which may expire, surplus inventory may not be utilized simply for outbound shipments 350 of another distribution warehouse in the present embodiment. Unlike excess inventory which may be costly to maintain in such quantities, surplus inventory may not be utilized for level demand 360 of another distribution warehouse in the present embodiment. For example, with reference to FIG. 2, surplus 258 of DW2 may be eligible for redistribution to DW1 to meet demand to fulfill shortage 224. As there are no shortages or level demand in DW3 in the present example, surplus inventory 258 would not be eligible for redistribution to DW3.

Alternative embodiments may utilize alternative restrictions on redistributing inventory supply from one distribution warehouse to another, whether by reallocating incoming shipments, by utilizing transfer shipments, or by reallocating outgoing shipments. It should be noted that reallocating incoming shipments or outgoing shipments may not directly move newer inventory to another distribution warehouse, but rather moves the overall supply of that inventory by redirecting the destinations of incoming and outgoing inventory to other distribution warehouses.

FIG. 4 depicts a diagram 400 of the utilization of time series with discrete time buckets for optimizing inventory levels across multiple distribution warehouses, in which various embodiments of the present disclosure may be implemented. That is, optimization of inventory levels may be provided across multiple periods of time, not just for current inventory levels. Inventory levels will change over time, so optimizing inventory levels across multiple time periods provides improved look-ahead capabilities as well as flexibility in addressing any suboptimal conditions.

In the present embodiment, a planning time span 410 is depicted starting at a time point of origin 420 and ending at a time horizon 430. Planning time span 410 may be a range of time in which inventory may be optimized by utilizing shipment reallocations and transfer shipments. The time point of origin (also referred to herein as a starting time) 420 may be in the near future, such as at the beginning of the next work shift or day. Starting time 420 may also be the current time. Generally, in the present embodiment, the starting time may the earliest time in which shipments may be reallocated or transfer shipments may be modified or planned. Time horizon (also referred to herein as an ending time) 430 may be the end of the shift started with starting time 420, the end of the current day or the day starting with starting time 420, or for further out time horizons such as in a few days. Ending time 430 may be based on limitations of identifying incoming and outgoing scheduled shipments, limitations on modeling inventory due to shrinkage or other historically identified issues, limitations on computing power and computing time available for optimizing inventory, management preferences, or other factors which may not be described herein.

Planning time span 410 may include a series of time slots shown as T1, T2, T3 . . . TN starting at time point of origin 420 and ending at time horizon 430. Each time slot may represent a period of time such as a work shift or a day. The time slots may be contiguous or may include time gaps such as when the distribution warehouses may be closed for lunch, the night or holidays. The time length and number of each time slot may be set based on avoiding inventory discontinuities whereby a shortage may be caused by outgoing shipments within the time slot creating a shortage of a certain good before incoming shipments within that same time slot replenishing that good. In addition, the time slots may be represent a predetermined uniform fixed amount of time, or they may represent variable amounts of time. For example, time slots in the near future may be only 15 minutes in length, but may expand to one hour each time slot later in the time span.

In the present embodiment, initial conditions 440 are identified including inventory levels of types of goods (i.e. good types) for each distribution warehouse across multiple distribution warehouses. In addition, any scheduled incoming shipments of goods 451, 452, 453 . . . 45N and any scheduled outgoing shipments of goods 461, 462, 463 . . . 46N are identified for each time slot for each distribution warehouse, including the types and amounts of each good contained in each shipment. Incoming shipments may include incoming shipments from suppliers as well as previously scheduled incoming transfer shipments from other distribution warehouses. Outgoing shipments may include outgoing shipments to customers as well as previously scheduled outgoing transfer shipments to other distribution warehouses. With this information, the expected inventory levels 441, 442, 443 . . . 43N, including supply and demand thereof, may be determined of each good for each distribution warehouse for each time slot. The expected inventory levels may represent the inventory levels at a given point of each time period, such as the beginning of the time period or the end of the time period. With this determination of inventory levels and identified incoming and outgoing shipments, adjustments may be identified and implemented to optimize inventory including reallocating incoming shipments, implementing transfer shipments, and reallocating outgoing shipments to customers.

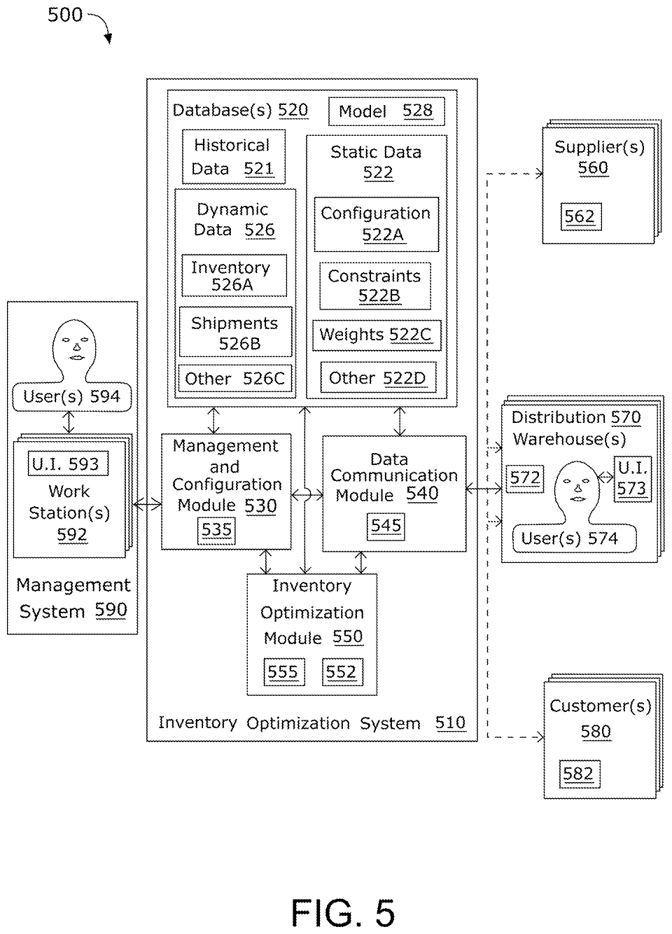

FIG. 5 depicts a high level block diagram 500 of an inventory optimization system 510 for dynamically optimizing inventory levels among multiple distribution warehouses through reallocating incoming and outgoing shipments and implementing transfer shipments, in which various embodiments of the present disclosure may be implemented. Inventory optimization system 510 may be implemented in a variety of locations and/or environments. For example, system 510 may be implemented at one of the distribution warehouses, at a central administrative office of a corporate entity that owns the distribution warehouses, at an administrative center of a cooperative that includes the distribution warehouses, in the cloud such as in a SaaS (software as a service) implementation, or other locations and environments as may be suitable for the given embodiment.

In the present embodiment, inventory optimization system 510 includes a set of databases 520 and three main modular subsystems, a data communication module 530, a management and configuration module 540, and an inventory optimization module 550. Other embodiments may utilize a different set of modules to perform inventory optimization. Optimization system 510 may communicate with suppliers 560, distribution warehouses 570 and customers 580, which may correspond respectively to suppliers 110, distribution warehouses 150 and customers 190 of FIG. 1. Typically, inventory optimization system 510 may only communicate with distribution warehouses 570 as depicted with a solid line and then rely on the distribution warehouses to handle any communications with suppliers and customers as depicted with dashed lines. Optimization system 510 may also communicate with management system 590 for configuration of the optimization system, for invocation of the optimization system, as well as for any approvals of recommended shipment reallocations or transfer shipments. Management system 590 may be located at or managed by an administrative office such as at a corporate entity that owns the distribution warehouses, although many other such locations and management may be utilized depending on the implementation.

Database 520 may be a single or multiple databases containing a variety of information useful for optimizing inventory across the multiple distribution warehouses. Database 520 may be centrally located, such as at administrative office, or it may be spread out in multiple locations, such as in the cloud or among the various distribution warehouses. Databases 520 may include historical data 521, static data 522, dynamic data 526 and inventory optimization model 528. Historical data 521 may be utilized for a variety of purposes including for use in performing statistical or other analysis for determining a time span, a number of time slots, rewards and penalties for optimizing inventory levels, and other uses such as described herein. Static data 522 may include a variety of types of data that typically does not vary much over time. That may include configuration information 522A such as applicable structural data that describes the locations and campuses of the multiple distribution warehouses, constraints and capacities 522B describing certain limitations or boundary conditions of various components such as structural items, incentive based weights 522D such as rewards and penalties for balancing different factors as described herein, and other static data 522D that may be useful in optimizing inventory levels across the multiple distribution warehouses. Dynamic data 526 may include data that changes frequently such as inventory levels 526A and scheduled shipments 526B. Other dynamic data 526C may also be stored in database 520 and utilized by system 510 in optimizing inventory. Inventory optimization model 528 may be a model of the distribution warehouse system including inventory levels across a time span which may be utilized by the inventory optimization system to optimize inventory levels as described herein. The inventory optimization model may be a linear programming model generated as described below. More details regarding the inventory optimization model including how it is generated and utilized are described below. In an alternative embodiment, multiple inventory optimization models may be utilized for comparing and/or combining results of each such model.

Management and configuration module 530 may perform several functions such as configuring system 510, managing operations of modules 540 and 550, and communicating recommended shipment reallocations and transfer shipments through user interface (U.I.) 593 with a user 594 in management system 590. In order to perform inventory optimization, system 510 needs to be configured. This may include communicating through a workstation 592 (i.e., a computer system including software such as a user interface) and user interface 593 with user 594 to establish static data 522 including configuration data 522A, constraints and capacities 522B, weights 522C and other static data 522D such as the time span and time periods utilized for optimizing inventory. When system 510 is run, module 530 may coordinate the actions of modules 540 and 550 so that dynamic data is gathered, manipulated as needed, and loaded into database 520 prior to module 540 performing inventory optimization and providing recommended shipment reallocations and transfer shipments. Management system 590 may then pass these recommendations to management system 590 for approval, modification or rejection by user 594. The resulting feedback by user 594 may then be passed back to data communication module 540 for communication to computer systems 572 of distribution warehouse 570, as well as with suppliers 560 and customers 580 if needed, for implementation of the approved or modified shipment reallocations and transfer shipments. Such recommended shipment reallocations and transfer shipments may also be passed to computer systems 572 of distribution warehouse 570 for communication to user(s) 574 through user interface (U.I.) 573. User(s) 574 may have an opportunity to approve, modify or reject such recommendations. Distribution warehouse(s) may also Alternative management and configuration modules may manage these various functions differently. For example, distribution warehouses 570 may push data regarding shipments and inventory to system 510 on a regular or as needed basis, thereby affecting how that data may be processed and stored. Management and configuration module 530 may include an artificial intelligence module 535 for assisting in some of the functions of module 530. For example, artificial intelligence may be utilized in developing and maintaining incentive based weights (i.e., rewards and penalties) used in inventory management. Alternative embodiments may utilize statistical or other analytical software in lieu of artificial intelligence.

Data communication module 540 manages communications with computer systems 572 of distribution warehouses 570 and any communications that may be needed with suppliers 560 and customers 580. This may be accomplished by establishing communications with distribution warehouse computer systems including software 572 as well as supplier software 562 and customer software 582 if applicable. In many cases, there may be no communications with suppliers 560 and customers 580 as the operations of the present embodiment may be invisible to the suppliers or customers unless there are some changes in arrival times of reallocated shipments. In the case of reallocated shipments, typically those communications may be handled by distribution warehouse computer systems software 572 of the applicable distribution warehouse 570.

Each distribution warehouse 570 may include a separate implementation or instance of computer system software 572 dedicated to that warehouse. In alternative embodiments, such software may be shared among multiple distribution warehouses. Distribution warehouse computer system software 572 may be one of a variety of software implementations including WMS (warehouse management software), YMS (yard management system), TMS (transportation management software), ERP (enterprise resource planning), and/or other types of software implementations including custom software or customized software packages. Given the variety of software available for software 572, data communication module 540 may be customized or configured to communicate with each such distribution warehouse software implementation. In the present embodiment, computer systems 572 and workstation(s) 592 may be collectively referred to a set of computer systems which may include software and may communicate with each other for implementing the present embodiment.

In a data pull environment, data communication module 540 may request from distribution warehouse software on computer system 572 updated data needed for optimizing inventory levels prior to such inventory optimization. This may include current known inventory levels for each good in each distribution warehouse or last known inventory levels, any incoming, outgoing or transfer shipments since known inventory levels, and scheduled shipments up to the time horizon of the inventory optimization. In a data push environment, data communication module 540 may receive inventory and shipment data from supplier software 562 and software of distribution warehouse computer systems 572 as that data is generated or periodically. Such inventory and shipment data, whether pulled or pushed, may be manipulated to a standard format and configuration for storage in database 520 and/or for use by optimization module 550. For example, distribution warehouse computer system software 572 may provide current inventory levels and scheduled outgoing shipments, whereas future scheduled incoming shipments may be provided by supplier software 562, such that future inventory levels may be predicted by combining this data from different sources. This data manipulation may be performed data communication module 540 and/or by management or configuration module 530 in the present embodiment. That is, module 540 may perform some simple data configuration on single source data whereas module 530 may perform data configuration on data from multiple sources. Data communication module 540 may include an artificial intelligence module 545 for assisting in some of the functions of module 540. For example, artificial intelligence may be utilized in filling in unknown inventory data that may not be available in time for use in inventory management. Alternative embodiments may utilize statistical or other analytical software in lieu of artificial intelligence.

Inventory optimization module 550 may perform inventory optimization through reallocating scheduled shipments from suppliers to distribution warehouses, reallocating shipments from distribution warehouses to customers, and scheduling transfer shipments of certain good types and quantities thereof between distribution warehouses. Inventory optimization module may utilize static and dynamic data stored in database 520 in performing this optimization. This optimization may be performed across multiple time periods in a time span utilizing a set of rewards and penalties in a linear programming model 552 to weigh the various factors involved in optimizing inventory levels. Model 552 may utilize model 522 stored in database 520 supplemented with current dynamic data for performing inventory optimization. Much of this process is described in greater detail below with reference to the flow diagrams. Inventory optimization module 550 may include an artificial intelligence module 555 for assisting in some of the functions of module 550. For example, artificial intelligence may be utilized in performing parallel inventory optimization including the use of historical data 521 for verifying or supplementing the results of inventory optimization utilizing linear programming techniques. Alternative embodiments may utilize statistical or other analytical software in lieu of artificial intelligence.

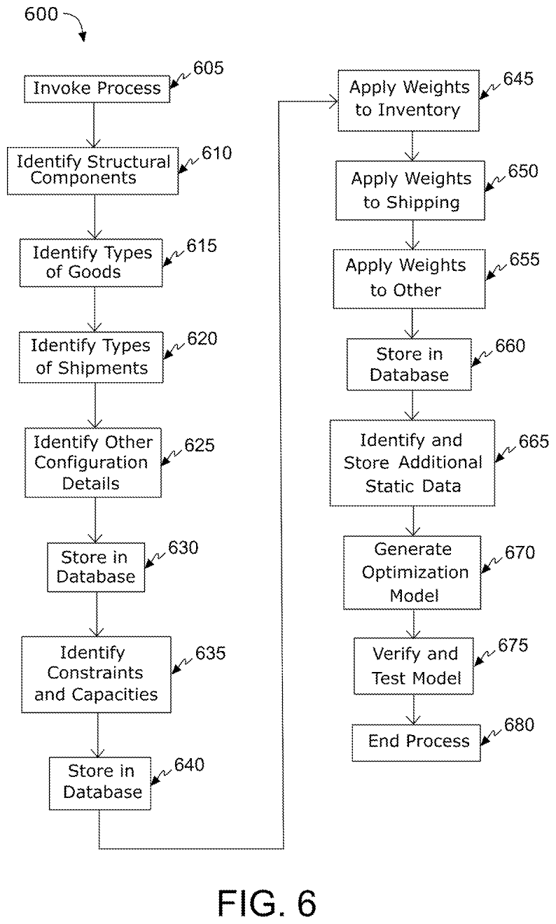

The inventory optimization system described with reference to FIG. 5 may be implemented in other configurations and may include additional or modified modules, databases and other elements and may be organized or implemented in different situations and/or environments as may be appreciated by one of ordinary skill in the art. Implementation and utilization of the present embodiment of the inventory optimization system is described below with reference to FIGS. 6 through 8 below.

FIG. 6 depicts a flow diagram 600 of a process for implementing and maintaining the static data of the inventory optimization system towards generating an inventory optimization model, in which various embodiments of the present disclosure may be implemented. That is, this process may be initiated when first implementing an embodiment and may be utilized again, in part or in whole, whenever there are changes to the embodiment represented by the static data. Each of the steps below may be performed with the assistance and/or input of one or more users such as user 594 or user 574 utilizing computer systems 592 and/or 592. To aid understanding of the present embodiment, FIG. 6 is described herein with reference to various elements of FIG. 1 and FIG. 5. References to FIGS. 1 and 5 are not intended to be limiting. Other such implementations may be easily utilized as may be appreciated by one of ordinary skill in the art.

In a first step 605, a process for implementing or maintaining an inventory optimization system is initiated, such as by user 594 through user interface 593. Alternatively, user 574 of distribution warehouse 570 may also initiate this process, particularly for maintenance such as for modifying certain inventory capacities or constraints specific to that distribution warehouse. As part of this process initiation, user 594 may specify whether this is for implementing a new inventory optimization system or for maintaining an existing inventory optimization system. If for maintenance, user 594 may specify which elements of the optimization system are needing maintenance, thereby skipping some of the below specified steps to the appropriate step.

The in step 610, structural components may be provided. Structural components may include identifying distribution warehouses 150 and their campuses and relative locations, suppliers 110 and customers 190, shipping lanes with suppliers 120 and customers 180 as well as between distribution warehouses 171 and 172. Other such structural components may be included for which various constraints and capacities may be later added such as grouping of inventory storage bays in a distribution warehouse. Step 610 may also be utilized in a maintenance mode to add a new distribution warehouse, supplier, shipping lanes, etc.

Subsequently, in step 615, types of goods that may be shipped from suppliers, stored in distribution warehouse inventory, picked, and shipped to customers or otherwise handled may be identified. In the present embodiment, any type of good that may be handled may be separately identified so as to be able to manage inventory for each and all such good types. This may include various identifiers of each good including name, product number, bar code, or other identifiers that may be utilized in the process of handling that good. In addition, each such good may be identified such as by pallet, group package, and/or individual package.

In step 620, types of shipments for given shipping lanes, whether incoming, outgoing or transfer, may be identified. In the present embodiment, this may include types of trucks or other vehicles, whether such incoming or outgoing shipments may be reallocated between distribution warehouses, limitations on the types of goods which may be shipped in transfer shipments (e.g., heavy pallets may not be able to transferred between distribution warehouses by vans), etc. Many other types of shipments and shipping lanes and associated goods may be identified based on the circumstances of the given underlying environment.

In step 625, other types of configuration details which may be needed for implementing the present embodiment for a given environment may be identified. This may include any additional components that may be needed for implementing an embodiment for a given environment. For example, the time span utilized and the number of time slots in that time span may be static over time. If static, that may be identified as other configuration data. For another example, types of goods identified in step 615 may be grouped into classes or other types of sets of goods. Such classifications may be useful for applying constraints and capacities, incentive based weights, or other purposes such as described herein. For a further example, certain or each type of goods may be classified into two or more subcategories such as newer and older. Additionally, types of dynamic data may be identified for collection and utilization as described herein. As would be appreciated by one of ordinary skill in the art, such implementation details may vary significantly between different environments, so flexibility of adding additional configuration details may be useful for a given embodiment.

In step 630, the structural components identified in step 610, the types of goods identified in step 615, the types of shipments identified in step 620, and other configuration details identified in step 625 may be stored in configuration 522A in database 520. These configuration details may be considered as a skeleton or framework which may be overlaid or otherwise interconnected with the constraints and capacities, incentive based weights and other factors as described herein.

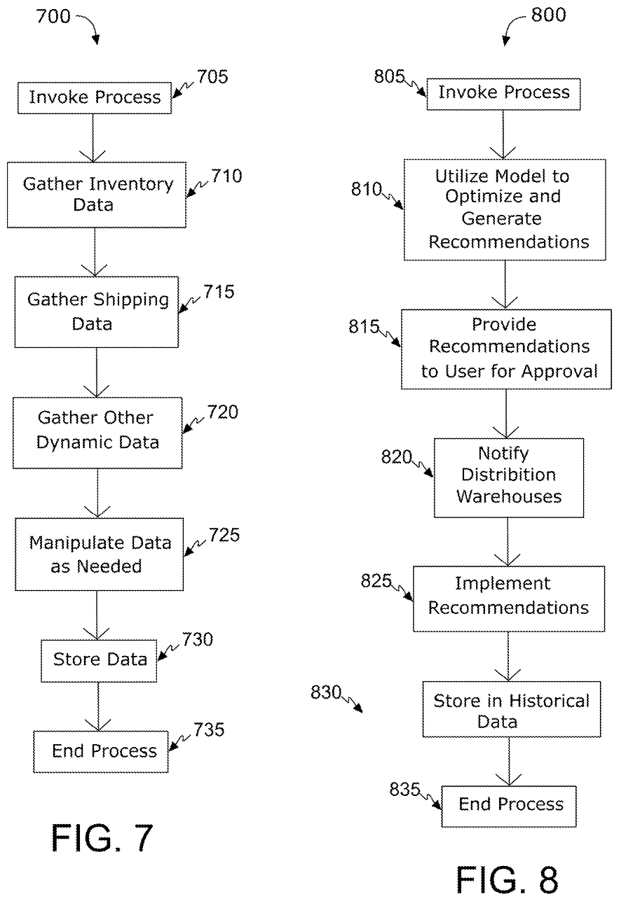

In step 635, any constraints or capacities applicable to the structural components, types of goods and types of shipments and shipping lanes may be identified. For example, the minimum and maximum levels for each good or class of goods in inventory may be identified. For another example, constraints and capacities of classifications or categories of good types (e.g., newer and older inventory) may be provided such as described above with reference to FIG. 3. For a further example, certain distribution warehouses may contain refrigeration capabilities, so those warehouses can handle refrigerated shipments whether other warehouses may not. Artificial intelligence 535 or other statistical analysis may utilize historical data 521 in identifying or otherwise recommending these minimum and maximum levels. As would be appreciated by one of ordinary skill in the art, such implementation details may vary significantly between different environments, so flexibility of adding additional configuration details may be useful for a given embodiment. In an alternative embodiment, minimum and maximum inventory levels may be more dynamic. In such an alternative, the minimum and maximum inventory levels may be obtained during the gathering of dynamic data as described with reference to FIG. 7 below. In step 640, the identified constraints and capacities may be stored in constraints and capacities 522B in database 520. The constraints and capacities may be considered and general limitations to the skeleton or framework as described as configuration details.

In step 645, incentive based weights may be applied to inventory and inventory levels. That is, rewards and penalties may be applied such as penalties for surplus inventory, excess inventory, short demand, older inventory and expiration of older inventory. In addition, rewards may be applied for meeting outbound demand and shipping older inventory prior to expiration. Such rewards and penalties may be estimations of actual costs and reduction of costs or they may simply be a point system that approximated desired or undesired situations and activities. These rewards and penalties may be identified for each type of good or by classes of goods, or other sets of goods. In an alternative embodiment, where minimum and maximum inventory levels may be considered dynamic data, such incentive based weighting of inventory levels may still be maintained centrally in database 720 as static data or such weighting may be considered dynamic as well and gathered during the gathering of dynamic data as described below with reference to FIG. 7. Artificial intelligence 535 or other statistical analysis may utilize historical data 521 in developing and maintaining these rewards and penalties utilized for managing inventory and inventory levels.

In step 650, incentive based weights may be applied to shipping and shipping reallocations and transfers. That is, rewards for successful shipments may be provided as well as costs for reallocating incoming or outgoing shipments as well as costs for transfer shipments. Such rewards and penalties may be estimations of actual costs and reduction of costs or they may simply be a point system that approximated desired or undesired situations and activities. Rewards and penalties for shipments may be supplier or customer based. That is, reallocating a supplier shipment may incur certain contractual or experience based fees. Also, some customers may have substantially increased penalties for shipments with shortages to those customers. Artificial intelligence 535 or other statistical analysis may utilize historical data 521 in developing and maintaining these rewards and penalties utilized for managing shipping and shipping reallocations and transfers.

In step 655, incentive based weights may be applied to other types of situations, actions or inactions that may occur. That is, various scenarios which may incur costs or save costs may be identified. Such identified scenarios may be implemented in this step. Subsequently, in step 660, the weights identified in steps 645, 650 and 655 may be stored in weights 522C in database 520. These incentive based weights may essentially flesh out the skeleton or framework as described herein. In step 665, given the wide variety of environments that the present embodiment may be implemented, additional static information not included in the above described steps may also be identified and then stored in other static data 522D. For example, the types of dynamic information to be gathered may be identified including its location(s) and format. This may include current inventory levels, scheduled shipments, etc. Although such information is dynamic, the type of dynamic information may be static for automatic gathering of that information as described with reference to FIG. 7 below.

Subsequently, in step 670, inventory optimization model 528 may be generated utilizing the configuration, constraints and capacities, incentive based weights and types of dynamic information identified above. An objective function of the model may be based on cost minimization (i.e., minimizing penalties versus rewards in the incentive based weights) with decision variables including a destination of the scheduled incoming shipment, origination of the outgoing shipments, and good types and quantities for transfer shipments. Model 528 may be a linear programming based model or other type of model such as artificial intelligence based model. Such a model may be automatically generated based on the information provided for review, modification and approval by user 594. When some the static information is being modified, such as with an addition of a new distribution warehouse, a prior optimization model may be modified rather than a new model generated. Then in step 675 the inventory optimization model, including the identified static information, may be verified and tested. Such verification and testing may include utilizing historical information including prior results of inventory optimization. Such verification and testing may be performed utilizing data sets and benchmarks for that purpose or artificial intelligence may be utilized for such verification and testing. Any subsequent corrections or other modifications to the inventory optimization model may be captured in the present embodiment by utilizing the process described with reference to FIG. 6. Processing may then cease in step 680 until step 605 is again invoked.

Although several steps in FIG. 6 reference storing data and other information in database 720, these storing steps may be combined in a single step. They are mentioned separately to demonstrate how the information collected for building the model may be developed over time utilizing multiple users working over multiple sessions. Many other such alternatives may be appreciated by one skilled in the art. In addition, artificial intelligence 535, 545 and/or 555 may include machine learning that may utilize historical data 521 and other external data for training and for use in providing recommended solutions such as described herein.

FIG. 7 depicts a flow diagram 700 of a process for invoking, collecting, manipulating and storing dynamic data of the inventory optimization system, in which various embodiments of the present disclosure may be implemented. That is, this process may be initiated just prior to the inventory optimization being invoked as described with reference to FIG. 8 below. Alternatively, this process may be invoked periodically at such time as the data would be up to date before invoking inventory optimization. The present embodiment is described utilizing a data-pull model. Alternatively, a data-push model may be utilized where the dynamic data is pushed by the distribution warehouses to the management and configuration module 535 through data communication module 545 continuously or periodically such that such dynamic data is already available in database 520 prior to performing an inventory optimization as described with reference to FIG. 8 below. Each of the steps below may be performed automatically or with the assistance and/or input of one or more users such as user 594 or user 574. Although the following is described below as gathering information from the distribution warehouses, alternative sources of this information may be gathered from other sources such as suppliers, customers or other third parties, whether indirectly through the distribution warehouses or directly from the suppliers, customers of other third parties. To aid understanding of the present embodiment, FIG. 7 is described herein with reference to various elements of FIG. 5. References to FIG. 5 are not intended to be limiting. Other such implementations may be easily utilized as may be appreciated by one of ordinary skill in the art.

In a first step 705, a process for gathering dynamic data for the inventory optimization system is invoked. This process may be invoked automatically at predetermined times or upon the occurrence of certain conditions, such as an unexpected shipment cancellation being detected. Alternatively, this process may be invoked upon the request of a user such as by user 594 through user interface 593 or user 574 of distribution warehouse 570.

In step 710, inventory data may be gathered from the distribution warehouses for each warehouse by data communication module 545 communicating with computer systems including distribution warehouse software 572. This may include current or last known inventory levels for each type of good, including newer inventory and older inventory. If last known stock levels, the date and time of those last known stock levels. If minimum and maximum inventory levels are considered dynamic, then the current minimum and maximum inventory levels for each type of good or class of goods may be gathered. Any other dynamic information regarding inventory levels may also be gathered.

Then in step 715, shipping data may be gathered from the distribution warehouses for each warehouse by data communication module 545 communicating with computer systems including distribution warehouse software 572. This may include a list of scheduled incoming shipments (also referred to herein as inbounds or receipts) for each distribution warehouse, a list of scheduled outgoing shipments (also referred to herein as outbounds) for each distribution warehouse, and a list of scheduled transfer shipments between distribution warehouses. Each scheduled shipment, whether inbound, outbound or transfer may include a list of goods including good type, volume of each good, scheduled arrival time and/or schedule departure time. If the inventory levels gathered in step 710 are not current, then all shipments since the date and time of last known inventory levels may be gathered, thereby allowing a calculation of current inventory levels. In step 720, any other dynamic data that was identified in step 665 of FIG. 6 above may be gathered from the distribution warehouses or other sources such as suppliers, customers or third parties.

In step 725, the gathered data may be manipulated to provide the data needed in the format needed for utilization by inventory optimization model 528. For example, the amount of surplus, excess, level demand, etc. may be calculated from current inventory levels, minimum and maximum desired inventory, incoming, outgoing and transfer shipments for each type of good. In addition, these calculations may be performed for each time period and each type of good including initial conditions. Other such calculations may be performed as needed depending on how the inventory optimization model was generated and the type of data available for manipulation from the distribution warehouses or other sources.

Upon the completion of such data manipulation, in step 730 the results may be stored in database 520 as historical data 521 and combined with underlying inventory optimization model 528 to generate updated inventory optimization model 552 with current dynamic data for usage by inventory optimization module 550 as described herein, or alternatively by utilizing artificial intelligence model 555 for such optimization, alone or in parallel with model 552. In an alternative embodiment, the resulting dynamic data including the manipulation thereof may be sent to user 594 or user 574 for review and possible modification. Processing may then end in step 735 before proceeding to running the inventory optimization module as described with reference to FIG. 8 below.

FIG. 8 depicts a flow diagram 800 for optimizing inventory during an upcoming time span across multiple distribution warehouses utilizing a generated inventory optimization model, in which various embodiments of the present disclosure may be implemented. To aid understanding of the present embodiment, FIG. 8 is described herein with reference to various elements of FIG. 5. References to FIG. 5 are not intended to be limiting. Other such implementations may be easily utilized as may be appreciated by one of ordinary skill in the art.

In a first step 805, a process for optimizing inventory during an upcoming time span across multiple distribution warehouses 570 utilizing updated inventory optimization model 552 is invoked. Alternatively, artificial intelligence 555 may be invoked and utilized for this optimization. This process may be invoked automatically at predetermined times or upon the occurrence of certain conditions, such as an unexpected shipment cancellation being detected. Alternatively, this process may be invoked upon the request of a user such as by user 594 through user interface 593 or user 574 of distribution warehouse 570.

Then in step 810, inventory optimization module utilizes inventory optimization model 552 (or alternatively or in parallel artificial intelligence module) to optimize inventory levels across the multiple distribution warehouses across multiple time periods in a predesignated time span. Given that the inventory optimization model includes static data previously identified and implemented in the model including structural data, configuration data including constraints and capacities, incentive based weights including rewards and penalties, and other relevant static information, plus up to date dynamic data gathered from the distribution warehouses including inventory levels and scheduled shipments, with an objective function to maximize a combination of positive rewards and negative penalties, such a model may provide a set of recommended reallocation of previously scheduled incoming shipments to alternative distribution warehouses, recommended reallocation of scheduled outgoing shipments from alternative distribution warehouses, as well as recommended transfer shipments of certain goods between distribution warehouses. Alternatively, artificial intelligence model 555 may provide the similar reallocation and transfer shipment recommendations, alone or in parallel with model 552, utilizing the static and dynamic data utilizing training including historical data.

In step 815, the recommended reallocation of scheduled shipments and recommended transfer shipments of identified goods are provided by inventory optimization module 550 to management and configuration module 535 to management system 590 for review, modification, and or approval of the recommendations by user 594. In an alternative embodiment, the recommendations may be provided to users 574 for their review, modification and/or approval, possibly after approval by user 594. If modification to the recommended reallocation and transfer shipments are made, the optimization process may be performed again with the changes being treated as constraints to identify whether other modifications would be appropriate. If both the linear programming model and artificial intelligence model are utilized, the results of both optimizations may be provided to the users with differences between the models recommendations highlighted.

Responsive to user approval of the recommended reallocations and transfers, distribution warehouses 570 are notified of the approved recommendations in step 820. Upon such notification, in step 825, computer systems with software 572 of distribution warehouses 570 may implement the approved recommended shipment reallocations and transfer shipments. This may include notifying the suppliers of any reallocations of incoming shipments, scheduling the receipt and unloading of the reallocated incoming shipments at the reallocated destination distribution warehouse, scheduling the loading and shipping of the reallocated outgoing shipments, scheduling the loading and shipping of the recommended transfer shipments at the sending distribution warehouse(s) as well as the receiving and unloading of the recommended transfer shipments at the receiving distribution warehouse(s). In addition, in step 830, the recommended and approved reallocated shipments and transfer shipments are stored in database 520 in historical data 521. Then in step 835, the recommended and approved reallocation and transfer shipments are implemented as recommended and approved. That is, the goods in the reallocated and transfer shipments may be received, unloaded, stored, picked, loaded and shipped as scheduled. Furthermore, Processing by inventory optimization system 510 may then cease in step 840 until step 805 is again invoked

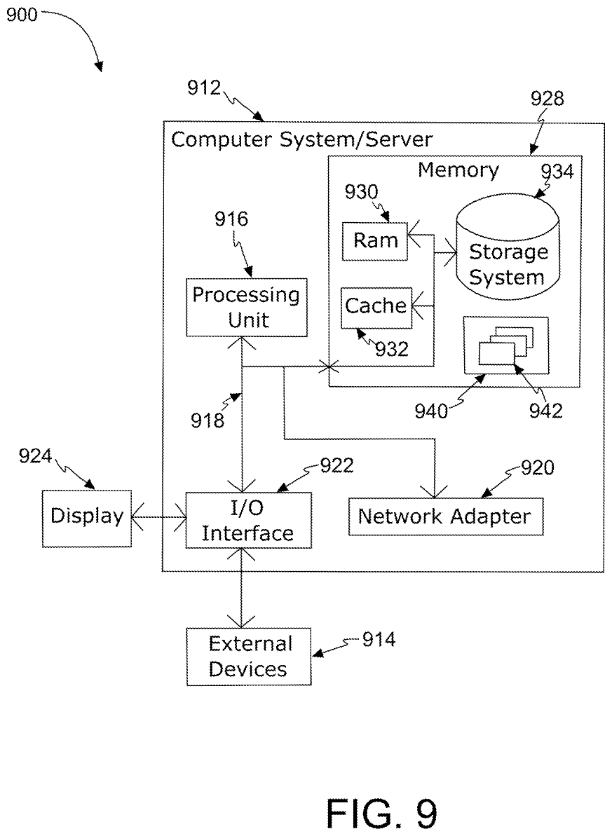

FIG. 9 depicts a block diagram of an illustrative data processing system in which various embodiments of the present disclosure may be implemented. Data processing system 900 is one example of a suitable data processing system and is not intended to suggest any limitation as to the scope of use or functionality of the embodiments described herein. Regardless, data processing system 900 is capable of being implemented and/or performing any of the functionality set forth herein such as dynamically optimizing inventory levels among multiple distribution warehouses through reallocating incoming and outgoing shipments and implementing transfer shipments among the distribution warehouses.

In data processing system 900 there is a computer system/server 912, which is operational with numerous other computing system environments, peripherals, or configurations. Examples of well-known computing systems, environments, and/or configurations that may be suitable for use with computer system/server 912 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 912 may be practiced in distributed computing environments where tasks are performed by remote processing devices that are linked through a communications network. In a distributed computing environment, program modules may be located in both local and remote computer system storage media including memory storage devices. For example, various embodiments of the systems and methods such as described herein may be implemented in a cloud computing environment, distributed or otherwise, which may be virtualized such as with the use of a hypervisor managing multiple nodes including virtual processors, virtual memory, etc.

As depicted in FIG. 9, computer system/server 912 in data processing system 900 is shown in the form of a general-purpose computing device. The components of computer system/server 912 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 912 typically includes a variety of non-transitory computer system usable media. Such media may be any available media that is accessible by computer system/server 912, and it includes both volatile and non-volatile media, removable and non-removable media.

System memory 928 may include non-transitory computer system readable media in the form of volatile memory, such as random access memory (RAM) 930 and/or cache memory 932. Computer system/server 912 may further include other non-transitory removable/non-removable, volatile/non-volatile computer system storage media. By way of example, storage system 934 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 918 by one or more data media interfaces. Memory 928 may include at least one program product having a set (e.g., at least one) of program modules that are configured to carry out the functions of the embodiments. Memory 928 may also include data that will be processed by a program product.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of the embodiments. For example, a program module may be software for dynamically optimizing inventory levels among multiple distribution warehouses through reallocating incoming and outgoing shipments and implementing transfer shipments among the distribution warehouses.

Computer system/server 912 may also communicate with one or more external devices 914 such as a keyboard, a pointing device, a display 924, etc.; one or more devices that enable a user to interact with computer system/server 912; and/or any devices (e.g., network card, modem, etc.) that enable computer system/server 912 to communicate with one or more other computing devices. Such communication can occur via I/O interfaces 922 through wired connections or wireless connections. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, tape drives, RAID systems, redundant processing units, data archival storage systems, external disk drive arrays, etc.

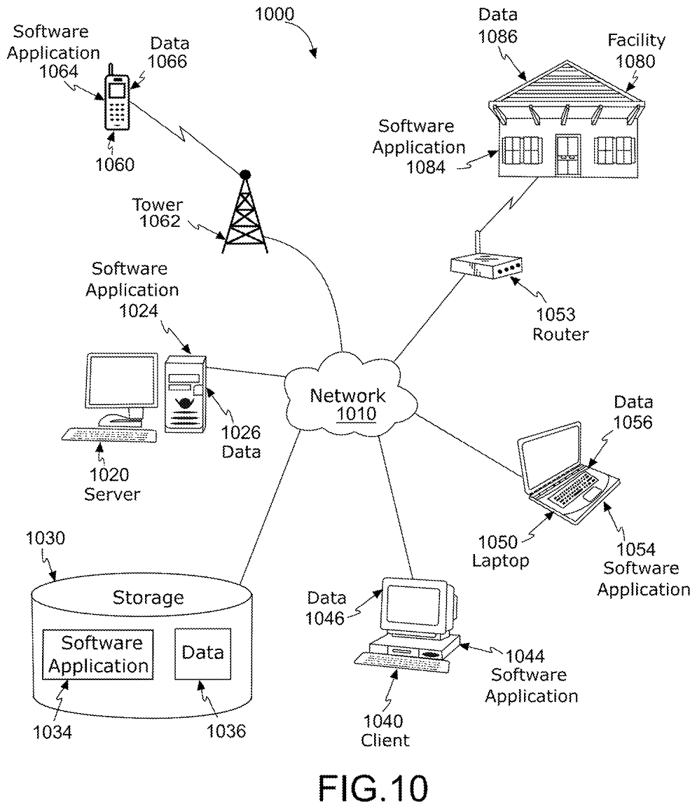

FIG. 10 depicts a block diagram of an illustrative network of data processing systems in which various embodiments of the present disclosure may be implemented. Data processing environment 1000 is multiple data processing systems such as described above with reference to FIG. 9. Software applications such as for dynamically optimizing inventory levels among multiple distribution warehouses through reallocating incoming and outgoing shipments and implementing transfer shipments among the distribution warehouses may be processed on any computer or other type of data processing system in data processing environment 1000. Data processing environment 1000 includes network 1010. Network 1010 is the medium used to provide simplex, half duplex and/or full duplex communications links between various devices and computers connected together within data processing environment 1000. Network 1010 may include connections such as wire, wireless communication links, or fiber optic cables.

Server 1020 and client 1040 are coupled to network 1010 along with storage unit 1030. In addition, laptop 1050 and facility 1080 (such as a home or business) are coupled to network 1010 including wirelessly such as through a network router 1053. A mobile device 1060 such as a mobile phone may be coupled to network 1010 through a cell tower 1062. Data processing systems, such as server 1020, client 1040, laptop 1050, mobile device 1060 and facility 1080 contain data and have software applications including software tools processing thereon. Other types of data processing systems such as personal digital assistants (PDAs), smartphones, tablets and netbooks may be coupled to network 1010.

Server 1020 may include software application 1024 and data 1026 for dynamically optimizing inventory levels among multiple distribution warehouses through reallocating incoming and outgoing shipments and implementing transfer shipments among the distribution warehouses or other software applications and data in accordance with embodiments described herein. Storage 1030 may contain software application 1034 and a content source such as data 1036 for dynamically optimizing inventory levels among multiple distribution warehouses through reallocating incoming and outgoing shipments and implementing transfer shipments among the distribution warehouses. Other software and content may be stored on storage 1030 for sharing among various computer or other data processing devices. Client 1040 may include software application 1044 and data 1046. Laptop 1050 and mobile device 1060 may also include software applications 1054 and 1064 and data 1056 and 1066. Facility 1080 may include software applications 1084 and data 1086 on local data processing equipment. Other types of data processing systems coupled to network 1010 may also include software applications. Software applications could include a web browser, email, or other software application for dynamically optimizing inventory levels among multiple distribution warehouses through reallocating incoming and outgoing shipments and implementing transfer shipments among the distribution warehouses.

Server 1020, storage unit 1030, client 1040, laptop 1050, mobile device 1060, and facility 1080 and other data processing devices may couple to network 1010 using wired connections, wireless communication protocols, or other suitable data connectivity. Client 1040 may be, for example, a personal computer or a network computer.

In the depicted example, server 1020 may provide data, such as boot files, operating system images, and applications to client 1040 and laptop 1050. Server 1020 may be a single computer system or a set of multiple computer systems working together to provide services in a client server environment. Client 1040 and laptop 1050 may be clients to server 1020 in this example. Client 1040, laptop 1050, mobile device 1060 and facility 1080 or some combination thereof, may include their own data, boot files, operating system images, and applications. Data processing environment 1000 may include additional servers, clients, and other devices that are not shown.

In the depicted example, data processing environment 1000 may be the Internet. Network 1010 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 1000 also may be implemented as a number of different types of networks, such as for example, an intranet, a local area network (LAN), or a wide area network (WAN). FIG. 10 is intended as an example, and not as an architectural limitation for the different illustrative embodiments.

Among other uses, data processing environment 1000 may be used for implementing a client server environment in which the embodiments may be implemented. A client server environment enables software applications and data to be distributed across a network such that an application functions by using the interactivity between a client data processing system and a server data processing system. Data processing environment 1000 may also employ a service oriented architecture where interoperable software components distributed across a network may be packaged together as coherent business applications.

Embodiments of the system and method for dynamically optimizing inventory levels among multiple distribution warehouses through reallocating incoming and outgoing shipments and implementing transfer shipments among the distribution warehouses may be implemented in any manner including as a computer program product at any possible technical detail level of integration. The computer program product may include a computer readable storage medium (or media) having computer readable program instructions thereon for causing a processor to carry out aspects of the embodiments of the system and method for dynamically optimizing inventory levels among multiple distribution warehouses through reallocating incoming and outgoing shipments and implementing transfer shipments among the distribution warehouses.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present system and method may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or other programming languages such as Java. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the system and method for dynamically optimizing inventory levels among multiple distribution warehouses through reallocating incoming and outgoing shipments and implementing transfer shipments among the distribution warehouses.

Aspects of the present system and method are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a special purpose machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present system and method. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for dynamically optimizing inventory levels among multiple distribution warehouses through reallocating incoming and outgoing shipments and implementing transfer shipments among the distribution warehouses. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present system and method have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the present system and method. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or operations plus function elements in the claims below are intended to include any structure, material, or act for performing the function in combination with other claimed elements as specifically claimed. The description of the present system and method has been presented for purposes of illustration and description, but is not intended to be exhaustive or limited to the system and method for dynamically optimizing inventory levels among multiple distribution warehouses through reallocating incoming and outgoing shipments and implementing transfer shipments among the distribution warehouses in the form disclosed. Many modifications and variations will be apparent to those of ordinary skill in the art. The embodiment was chosen and described in order to best explain the principles of the system and method and the practical application, and to enable others of ordinary skill in the art to understand the system and method for various embodiments with various modifications as are suited to the particular use contemplated.

What is claimed is:

1. A data processing system for dynamically optimizing inventory of multiple types of goods among multiple distribution warehouses across multiple time periods within a time span, the data processing system comprising:
a processor; and
a memory storing program instructions which when processed by the processor perform the operations of:
responsive to user input, receiving from a set of computer systems an identified configuration of the multiple distribution warehouses including associated incoming shipping lanes, associated outgoing shipping lanes and transfer shipping lanes among the multiple distribution warehouses;
receiving from the set of computer systems an identified set of good types suitable for receipt by the multiple distribution warehouses on the associated incoming shipping lanes, storage as inventory in the multiple distribution warehouses, transfer among the multiple distribution warehouses on the transfer shipping lanes, and shipment from the multiple distribution warehouses on associated outgoing shipping lanes;
responsive to user input, receiving from the set of computer systems an identified set of constraints and capacities applicable to the identified configuration of the multiple distribution warehouse including shipping lanes for incoming, outgoing and transfer shipments on the shipping lanes to, from and among the multiple distribution warehouses and applicable to inventory levels for storing the set of good types in the multiple distribution warehouses;
receiving from the set of computer systems a set of incentive based weights associated with inventory levels of the set of good types stored in the multiple distribution warehouses and associated with incoming, outgoing and transfer shipments on the shipping lanes to, from and among the multiple distribution warehouses;
generating a model of the multiple distribution warehouses including the identified configuration of the multiple distribution warehouses and shipping lanes, the identified set of good types, the identified set of constraints and capacities, and the incentive based weights associated with inventory levels and shipping lanes, the model including incoming shipment destinations and outgoing shipment originations as decision variables and including transfer shipments with good types and quantities thereof as decision variables;
receiving from the set of computer systems a set of current inventory levels of the set of good types;
receiving from the set of computer systems a set of scheduled incoming, outgoing and transfer shipments over the time span including good types and quantities thereof included in each of the scheduled shipments;
determining inventory levels for each of the good types for each distribution warehouse for each of a set of time periods across the time span;
utilizing the model to optimize inventory levels, based on the incentive based weights, for each of the good types in each distribution warehouse across the set of time periods across the multiple distribution warehouses by identifying reallocations of incoming shipment destinations, reallocations of outgoing shipment originations, and good types and quantities thereof of transfer shipments;
providing the reallocations and transfer shipments identified by the model to the set of computer systems for user approval;
responsive to receiving user approval, providing notification of the approved shipment reallocations and transfer shipments to the distribution warehouses for implementation; and
implementing the approved shipment reallocations and transfer shipments including receiving incoming shipments at the reallocated destinations, shipping outgoing shipments from the reallocated originations, and shipping and receiving transfer shipments including identified good types and quantities.

2. The data processing system of claim 1 wherein the model is a linear programming based model for optimizing inventory levels across multiple distribution warehouses.

3. The data processing system of claim 1 wherein the model is an artificial based model trained utilizing historical data and utilizing machine learning for optimizing inventory levels across multiple distribution warehouses.

4. The data processing system of claim 1 further comprising, responsive to user input, categorizing selected good types into newer inventory and older inventory; wherein constraints regarding the good type categorizations are identified; wherein incentive based weights regarding the good type categorizations are identified; and wherein the constraints and incentive based weights regarding the good type categorizations are included in the generated model to optimize inventory levels.

5. The data processing system of claim 1 further comprising, responsive to user input, grouping selected good types into common classifications; wherein constraints, capacities and incentive based weights associated with a good type common classification apply to each good type grouped in that common classification.

6. The data processing system of claim 1 further comprising utilizing historical data to update the constraints, capacities and incentive based weights to update the generated model.

7. The data processing system of claim 6 wherein artificial intelligence is utilized for identifying the constraints, capacities and incentive based weights to update the generated model.

8. A method of dynamically optimizing inventory of multiple types of goods among multiple distribution warehouses across multiple time periods within a time span, the method comprising:
responsive to user input, receiving from a set of computer systems an identified configuration of the multiple distribution warehouses including associated incoming shipping lanes, associated outgoing shipping lanes and transfer shipping lanes among the multiple distribution warehouses;
receiving from the set of computer systems an identified set of good types suitable for receipt by the multiple distribution warehouses on the associated incoming shipping lanes, storage as inventory in the multiple distribution warehouses, transfer among the multiple distribution warehouses on the transfer shipping lanes, and shipment from the multiple distribution warehouses on associated outgoing shipping lanes;
responsive to user input, receiving from the set of computer systems an identified set of constraints and capacities applicable to the identified configuration of the multiple distribution warehouse including shipping lanes for incoming, outgoing and transfer shipments on the shipping lanes to, from and among the multiple distribution warehouses and applicable to inventory levels for storing the set of good types in the multiple distribution warehouses;
receiving from the set of computer systems a set of incentive based weights associated with inventory levels of the set of good types stored in the multiple distribution warehouses and associated with incoming, outgoing and transfer shipments on the shipping lanes to, from and among the multiple distribution warehouses;
generating a model of the multiple distribution warehouses including the identified configuration of the multiple distribution warehouses and shipping lanes, the identified set of good types, the identified set of constraints and capacities, and the incentive based weights associated with inventory levels and shipping lanes, the model including incoming shipment destinations and outgoing shipment originations as decision variables and including transfer shipments with good types and quantities thereof as decision variables;
receiving from the set of computer systems a set of current inventory levels of the set of good types;
receiving from the set of computer systems a set of scheduled incoming, outgoing and transfer shipments over the time span including good types and quantities thereof included in each of the scheduled shipments;
determining inventory levels for each of the good types for each distribution warehouse for each of a set of time periods across the time span;
utilizing the model to optimize inventory levels, based on the incentive based weights, for each of the good types in each distribution warehouse across the set of time periods across the multiple distribution warehouses by identifying reallocations of incoming shipment destinations, reallocations of outgoing shipment originations, and good types and quantities thereof of transfer shipments;
providing the reallocations and transfer shipments identified by the model to the set of computer systems for user approval; and
responsive to receiving user approval, providing notification of the approved shipment reallocations and transfer shipments to the distribution warehouses for implementation.

9. The method of claim 8 wherein the model is a linear programming based model for optimizing inventory levels across multiple distribution warehouses.

10. The method of claim 8 wherein the model is an artificial based model trained utilizing historical data and utilizing machine learning for optimizing inventory levels across multiple distribution warehouses.

11. The method of claim 8 further comprising, responsive to user input, categorizing selected good types into newer inventory and older inventory; wherein constraints regarding the good type categorizations are identified; wherein incentive based weights regarding the good type categorizations are identified; and wherein the constraints and incentive based weights regarding the good type categorizations are included in the generated model to optimize inventory levels.

12. The method of claim 8 further comprising, responsive to user input, grouping selected good types into common classifications; wherein constraints, capacities and incentive based weights associated with a good type common classification apply to each good type grouped in that common classification.

13. The method of claim 8 further comprising utilizing historical data to update the constraints, capacities and incentive based weights to update the generated model.

14. The method of claim 13 wherein artificial intelligence is utilized for identifying the constraints, capacities and incentive based weights to update the generated model.

15. A computer program product for dynamically optimizing inventory of multiple types of goods among multiple distribution warehouses across multiple time periods within a time span, the computer program product comprising a computer readable storage medium having program instructions embodied therewith, the program instructions processed by a processing circuit to cause the device to perform a method comprising:
a processor; and
a memory storing program instructions which when processed by the processor perform the operations of:
responsive to user input, receiving from a set of computer systems an identified configuration of the multiple distribution warehouses including associated incoming shipping lanes, associated outgoing shipping lanes and transfer shipping lanes among the multiple distribution warehouses;
receiving from the set of computer systems an identified set of good types suitable for receipt by the multiple distribution warehouses on the associated incoming shipping lanes, storage as inventory in the multiple distribution warehouses, transfer among the multiple distribution warehouses on the transfer shipping lanes, and shipment from the multiple distribution warehouses on associated outgoing shipping lanes;
responsive to user input, receiving from the set of computer systems an identified set of constraints and capacities applicable to the identified configuration of the multiple distribution warehouse including shipping lanes for incoming, outgoing and transfer shipments on the shipping lanes to, from and among the multiple distribution warehouses and applicable to inventory levels for storing the set of good types in the multiple distribution warehouses;
receiving from the set of computer systems a set of incentive based weights associated with inventory levels of the set of good types stored in the multiple distribution warehouses and associated with incoming, outgoing and transfer shipments on the shipping lanes to, from and among the multiple distribution warehouses;
generating a model of the multiple distribution warehouses including the identified configuration of the multiple distribution warehouses and shipping lanes, the identified set of good types, the identified set of constraints and capacities, and the incentive based weights associated with inventory levels and shipping lanes, the model including incoming shipment destinations and outgoing shipment originations as decision variables and including transfer shipments with good types and quantities thereof as decision variables;
receiving from the set of computer systems a set of current inventory levels of the set of good types;
receiving from the set of computer systems a set of scheduled incoming, outgoing and transfer shipments over the time span including good types and quantities thereof included in each of the scheduled shipments;
determining inventory levels for each of the good types for each distribution warehouse for each of a set of time periods across the time span;
utilizing the model to optimize inventory levels, based on the incentive based weights, for each of the good types in each distribution warehouse across the set of time periods across the multiple distribution warehouses by identifying reallocations of incoming shipment destinations, reallocations of outgoing shipment originations, and good types and quantities thereof of transfer shipments;
providing the reallocations and transfer shipments identified by the model to the set of computer systems for user approval; and
responsive to receiving user approval, providing notification of the approved shipment reallocations and transfer shipments to the distribution warehouses for implementation.

16. The computer program product of claim 15 wherein the model is a linear programming based model for optimizing inventory levels across multiple distribution warehouses.

17. The computer program product of claim 15 wherein the model is an artificial based model trained utilizing historical data and utilizing machine learning for optimizing inventory levels across multiple distribution warehouses.

18. The computer program product of claim 15 further comprising, responsive to user input, categorizing selected good types into newer inventory and older inventory; wherein constraints regarding the good type categorizations are identified; wherein incentive based weights regarding the good type categorizations are identified; and wherein the constraints and incentive based weights regarding the good type categorizations are included in the generated model to optimize inventory levels.

19. The computer program product of claim 15 further comprising, responsive to user input, grouping selected good types into common classifications; wherein constraints, capacities and incentive based weights associated with a good type common classification apply to each good type grouped in that common classification.

20. The computer program product of claim 15 further comprising utilizing historical data to update the constraints, capacities and incentive based weights to update the generated model; wherein artificial intelligence is utilized for identifying the constraints, capacities and incentive based weights to update the generated model.
